(19) United States
(12) Patent Application Publication
(10) Pub. No.: US 2011/0155880 A1
(43) Pub. Date: Jun. 30, 2011

(54) Holder Apparatus

(76) Inventor: Robert William Stimpson, Isle of Man (GB)

(21) Appl. No.: 13/060,275

(22) PCT Filed: Jan. 23, 2009
(86) PCT No.: PCT/GB2009/000184

§ 371 Date: Feb. 23, 2011

(30) Foreign Application Priority Data
Sep. 4, 2008 (GB) PCT GB2008 002988

(51) Int. Cl. E03C 1/06; F16M 13/00

(52) U.S. Cl. 248/285.1; 248/286.1

(57) ABSTRACT

Holder apparatus (10) comprises an elongate holder bar (12), a holder element (18) which is slidably mounted on the holder bar (12) and which has a holder (24) for holding an item (30), and adjustment means (50, 52) for adjusting a position of the holder element (18) on the holder bar (12). The adjustment means (50, 52) has a user interface element (50) which is operable by a user to adjust a position of the holder element (18) on the holder bar (12), and the user interface element (50) is spaced from the holder element (18). Preferably, the adjustment means (50, 52) includes a drive element (52) which is in the holder bar (12) and which interconnects the interface element (50) with the holder element (18). Furthermore, the interface element (50) may preferably be retained at or adjacent to one end of the holder bar (12). The interface element (150) may include an epicyclic gear mechanism (194). Preferably, the holder apparatus is shower-head holder apparatus for holding and remotely moving a shower head (30).

The present invention relates to remotely controllable holder apparatus.

A shower installation in a multiple occupancy building, such as a home, can often be shared by both able-bodied and disabled or infirm users. A disabled or infirm user can be restricted to a shower seat or shower wheel-chair. In these cases, frequently the shower head is inadvertently placed out of reach of the seated user by the able-bodied users.

Similar problems can occur with young children being unable to reach and replace a shower head slidably mounted on a riser and riser rail device.

It would also be beneficial to be able to provide a device holder which can be manipulated remotely. This would have applications in a wide variety of industries, and not just for a shower installation.

The present invention seeks to provide a solution to these problems.

According to a first aspect of the present invention, there is provided holder apparatus comprising: an elongate holder bar; a holder element slidably mounted on the holder bar, the holder element having a holder for holding an item; and adjustment means for adjusting a position of the holder element on the holder bar, the adjustment means having a user interface element which is operable by a user to adjust a position of the holder element on the holder bar, the user interface element being spaced from the holder element.

Preferable and/or optional features of the invention are set forth in claims 2 to 24, inclusive.

According to a second aspect of the invention, there is provided a shower installation having holder apparatus in accordance with the first aspect of the invention and a shower head which is holdable and remotely movable by the holder apparatus.

According to a third aspect of the invention, there is provided an installation having holder apparatus in accordance with the first aspect of the invention and an item which is holdable and remotely movable by the holder apparatus.

The invention will now be more particularly described, by way of example only, with reference to the accompanying drawings, in which:

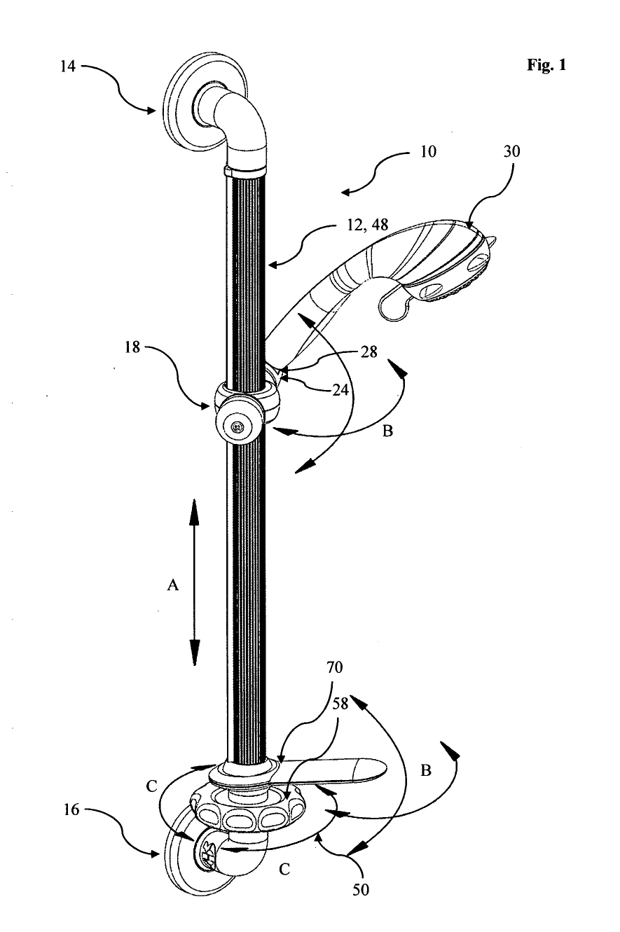

FIG. 1 is a perspective view of a first embodiment of shower-head holder apparatus, in accordance with the invention;

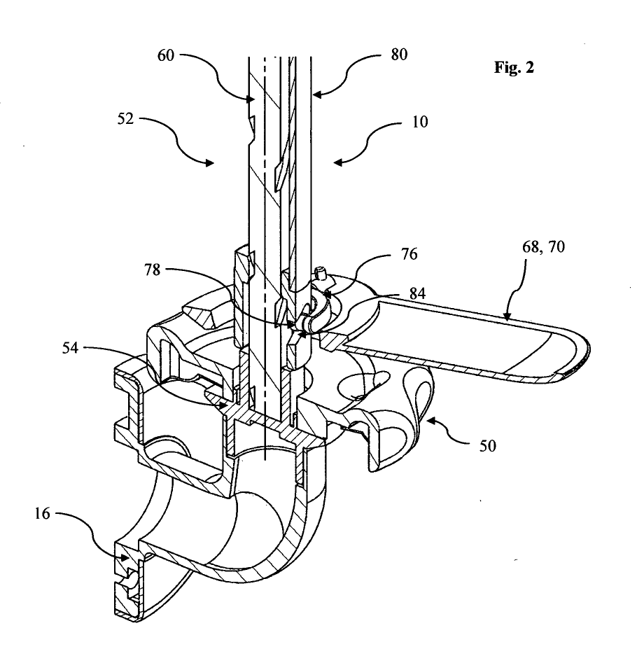

FIG. 2 is a perspective view of the portion of the shower-head holder apparatus shown in FIG. 1, with a knuckle and holder bar removed for clarity;

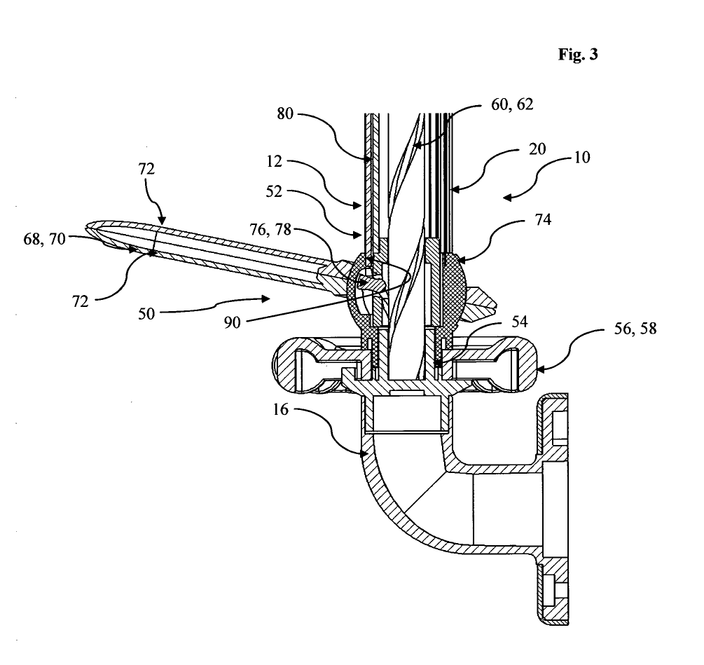

FIG. 3 is a partial cross-sectional view of adjustment means and a user interface element of the shower-head holder apparatus;

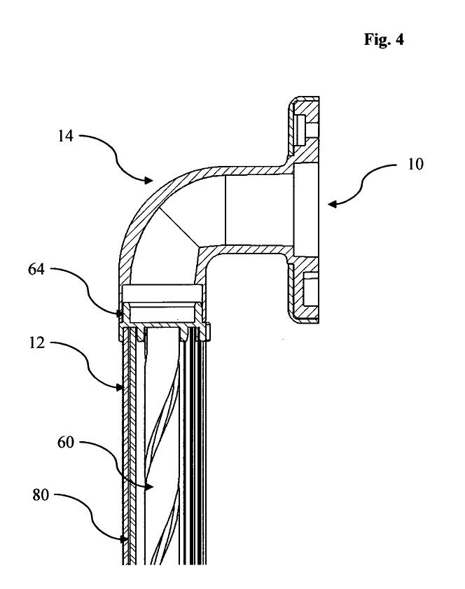

FIG. 4 is a cross-sectional view of an upper portion of the shower-head holder apparatus;

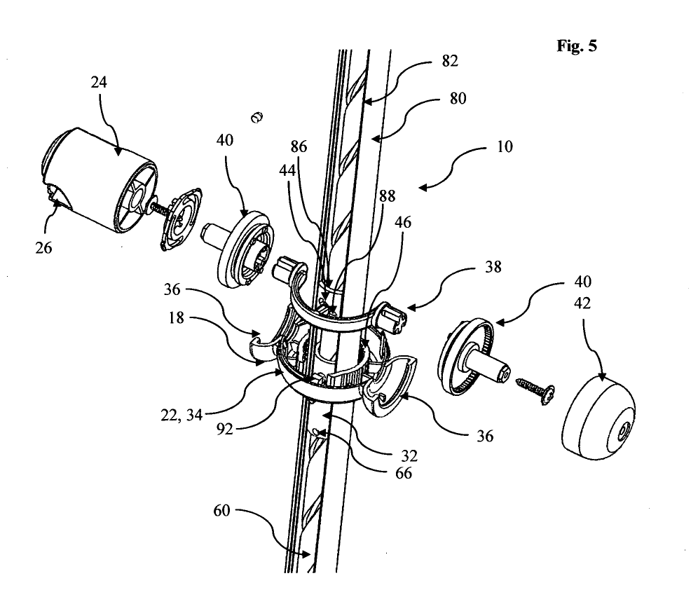

FIG. 5 is a partially exploded perspective view of a holder element of the shower-head holder apparatus;

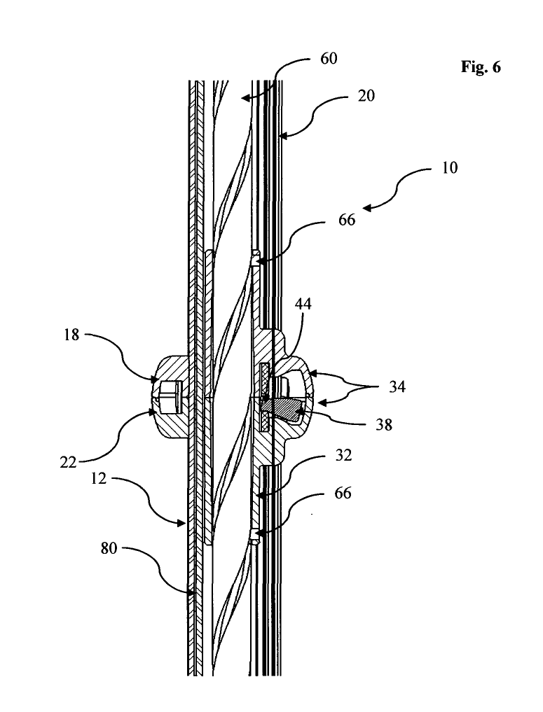

FIG. 6 is an enlarged partial cross-sectional view through the riser along an upper yoke pin;

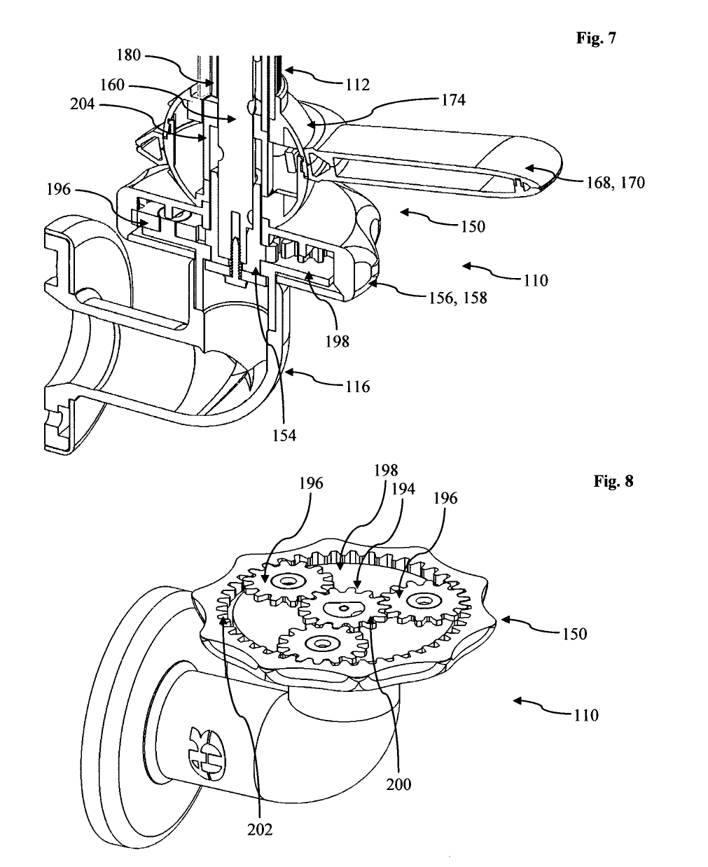

FIG. 7 is a view similar to FIG. 2 showing a portion of a second embodiment of shower-head holder apparatus, in accordance with the invention;

FIG. 8 is a perspective view of part of a user interface element of adjustment means of the shower-head holder apparatus, shown in FIG. 7;

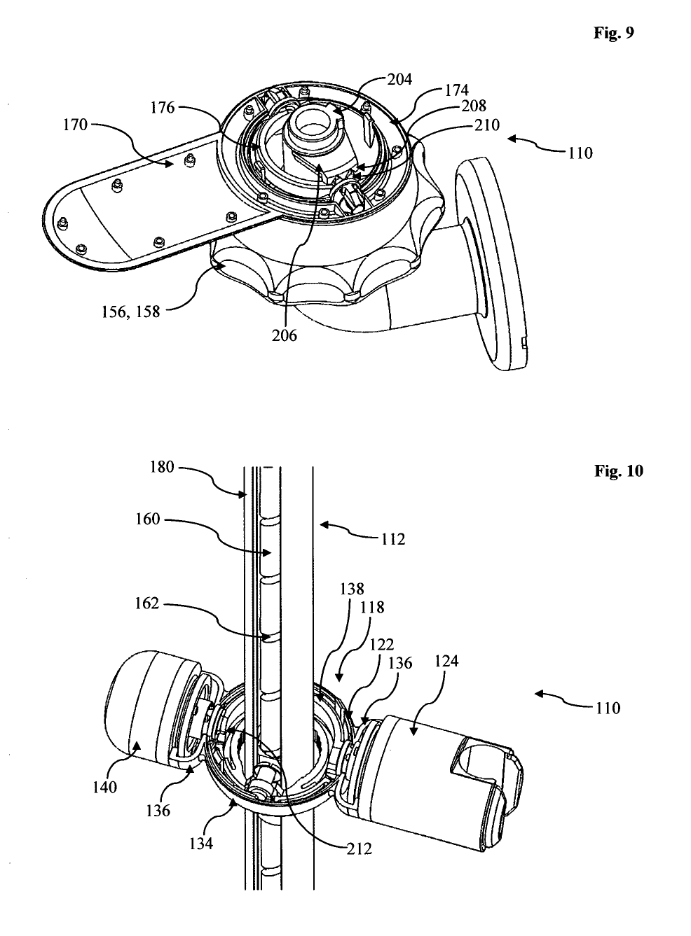

FIG. 9 is a view from above of part of the adjustment means and a user interface element of the second embodiment of shower-head holder apparatus;

FIG. 10 shows part of a holder element of the second embodiment of the shower-head holder apparatus;

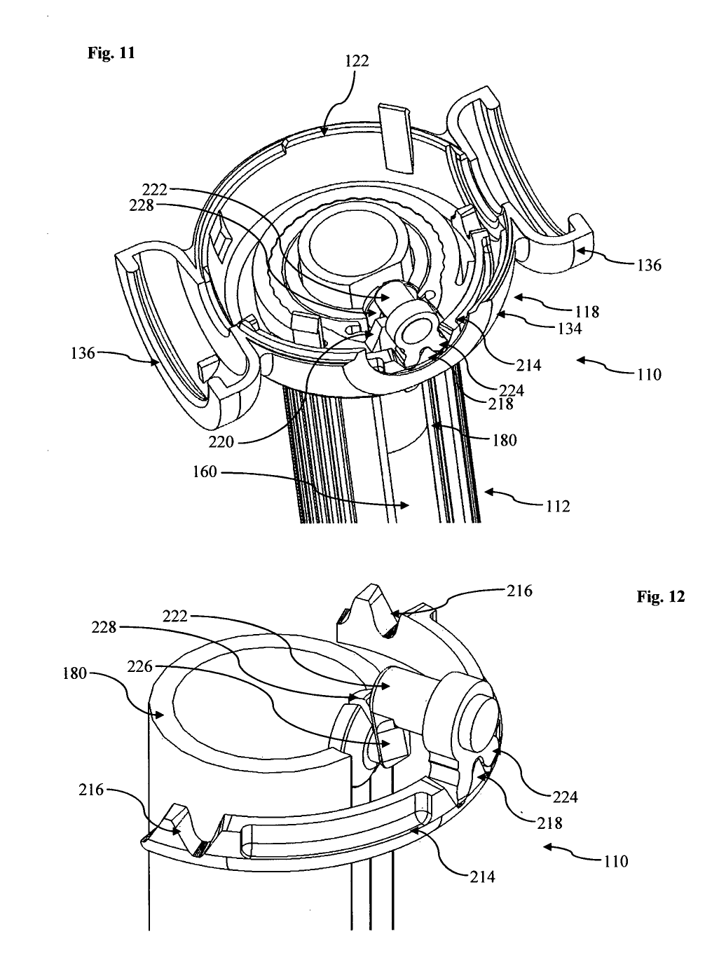

FIG. 11 is an enlarged view of part of the holder element shown in FIG. 10; and

FIG. 12 is another view of part of the holder element.

Referring to the drawings, there is shown a first embodiment of holder apparatus 10 which, in this case, is adapted to hold a shower-head and which comprises a, typically plastics or metal, elongate riser bar or rail 12 vertically fixed to a supporting surface via upper and lower brackets 14, 16, a shower-head riser 18 which is slidably mounted to the riser rail 12, and adjustment means for adjusting a position of the riser 18 on the riser rail 12.

The riser rail 12 has a C-shaped lateral cross-section, thereby providing a narrow rectilinear slot 20 along its longitudinal extent. The slot 20 is directed to face the supporting surface, so that it is generally hidden from view. A flexible, typically elastomeric, seal is provided in the slot 20 along the longitudinal extent. Preferably, the seal has two flexible seal parts which project from opposing edges of the slot 20 and meet at the centre of the slot 20 to prevent or limit the ingress of water into the interior of the riser rail 12. An outer surface of the riser rail 12 preferably has the appearance of a standard riser or hand rail.

The riser 18 is best shown in FIGS. 1 and 5 and includes a riser body 22 which can slidably move along the longitudinal extent of the riser rail 12, and a shower-head holder 24 which is pivotably connected to one side of the riser body 22. The shower-head holder 24 preferably includes a slightly tapered opening 26 for releasably receiving a ferule 28 of a shower head 30 or shower hose as a wedge fit.

The riser body 22 includes an inner riser sleeve 32 which is slidably received internally within the riser rail 12, a two part generally toroidal casing 34 which is slidably received on an exterior surface of the riser rail 12, two mounting elements 36 projecting oppositely from an equatorial region of the toroidal casing 34, and a pivotable upper yoke 38 which extends between the two mounting elements 36.

A pivot block 40 pivotably supports one end of the upper yoke 38 in one of the mounting elements 36, and this mounting element 36 is then closed by a cap 42. A second pivot block 40 supports the other end of the upper yoke 38 in the other mounting element 36, and this mounting element 36 is closed by the attachment of the shower-head holder 24. Both pivot blocks 40 are keyed to the respective ends of the upper yoke 38, and thus rotate with any pivoting of the upper yoke 38. The shower-head holder 24 is a received as a friction fit on an axle of its pivot block 40, allowing it to be rotated by hand for coarse adjustment as well as allowing fine angular adjustment through pivoting of the upper yoke 38.

Cap 42 and holder 24 are interchangeable to allow the installer to select the side of the device onto which the shower head hose may conveniently be placed.

Although two mounting elements 36 are suggested, being useful for mounting the shower-head holder 24 either side of the riser body 22, the pivot block with blanking cap may be dispensed with.

The upper yoke 38 is held within the toroidal casing 34, and includes an upper yoke pin 44 which is provided on an arcuate portion of the upper yoke 38 midway between the ends of the upper yoke 38. The upper yoke pin 44 extends through the slot 20 and seal of the riser rail 12 to the interior.

The toroidal casing 34 may preferably include a plurality of recesses 46 around its innermost surface to engage with complementary ridges 48 on an outer surface of the riser rail 12 and which extend in parallel with a longitudinal axis of the riser rail 12. As such, although the riser 18 is slidable on the riser rail 12, the riser 18 and riser body 22 are preferably angularly fixed relative to each other.

The adjustment means includes a user interface element 50 and a drive element 52 which is within the riser rail 12 and which interconnects the interface element 50 with the riser 18. The user interface element 50 is permanently retained at or adjacent to a lowermost end of the riser rail 12 so as to be spaced from the riser 18, and, in this embodiment, is conveniently interposed between the end of the riser rail 12 and the associated wall bracket 16. The user interface element 50 comprises a lower adapter 54 which is rotatably mounted in one end of the lower bracket 16, and a first user control member 56 in the form of a wheel 58 which is keyed or interlocked with the lower adapter 54 so that both are angularly fixed relative to each other. The drive element 52 includes an elongate helical guide member 60 which coaxially extends from the lower adapter 54. The helical guide member 60 is typically in the form of a rigid rectilinear bar with one or more discrete helical flutes 62 along its longitudinal extent, and an uppermost end is rotatably received in an upper adapter 64 which is rotatably mounted in an end of the upper bracket 14. The helical guide member 60 is angularly fixed at its lower end to the lower adapter 54 so as to rotate therewith upon angular displacement of the wheel 58.

The riser sleeve 32 of the riser body 22 includes spaced apart upper and lower followers 66, as best seen in FIG. 6, which are engaged with the flute 62 of the helical guide member 60. Therefore, as the wheel 58 is rotated by a user, the followers 66 are forced to travel along the helical guide member 60, thereby moving the associated riser 18 along the riser rail 12.

The user interface element 50 further comprises a second user control member 68 in the form of a paddle or lever 70. The second user control member 68 is separate and independent of the first user control member 56. The lever 70 is preferably, but not essentially, formed of two similar parts 72 and is pivotably mounted to a rotatable knuckle housing 74 which in this embodiment is generally spherical, but which may be other shapes, such as cylindrical. The knuckle housing 74 is mounted for rotation on the lower adapter 54 and is supported for independent rotation by the wheel 58. A lower yoke 76 having a lower yoke pin 78 midway along its arcuate extent is fixed to the pivot axis of the lever 70.

The drive element 52 further includes an elongate axial drive member 80 which is rotatable independently of the helical guide member 60. The axial drive member 80 is provided within the riser rail 12, and has a C-shaped lateral cross-section. A slot 82 therefore also extends along the longitudinal extent of the axial drive member 80, and this slot 82 is generally aligned with the slot 20 of the riser rail 12. The helical guide member 60 is provided within the axial drive member 80. Consequently, the helical guide member 60, the axial drive member 80 and the riser rail 12 are coaxial or substantially coaxial and concentric with each other.

A lower helical slot or channel 84 is formed in a wall of the axial drive member 80, adjacent to its lower end. The lower helical channel 84 has a relatively short longitudinal extent, extending less than one revolution of the axial drive member 80 and extending, for example, about 30 degrees. The lower yoke pin 78 is slidably received in the lower helical channel 84.

A slider element 86 having an identical or similar upper helical slot or channel 88 is provided as a close or tight fit in the slot 82 of the axial drive member 80 at the riser body 22. The upper yoke pin 44 of the upper yoke 38 is slidably received in the upper helical channel 88.

A lower end of the riser rail 12 is keyed or interlocked with the knuckle housing 74, conveniently by utilising the ridges 48 on the exterior surface of the riser rail 12 and complementary recesses on an interior surface 90 of the knuckle housing 74. The lever 70 typically does not turn through more than 360 degrees, and due to its length causing impingement on a bracket supporting wall, is typically only angularly displaceable through about 270 degrees in the horizontal plane.

In use, shower-head holder apparatus 10 is provided with the riser rail 12 being of suitable length to provide showering positions for an infirm or disabled user, and/or a young child, as well as an able bodied adult. The lower bracket is provided on a wall surface at a position at which a seated user and/or child can comfortably reach. The first user control member 56, being the wheel 58, can thus be rotated easily through more or less than 360 degrees. This movement only causes the helical guide member 60 to rotate within the riser rail 12, which in turn causes the followers 66 on the sleeve 32 to move along the flute or flutes 62. The riser body 22 which is attached to the sleeve 32 via a spoke 92 which projects through the slot 20 and seal thus moves up or down the riser rail 12 in the direction of arrows A in FIG. 1 depending on the direction of rotation of the wheel 58. Consequently, the shower-head holder 24 which is attached to the riser body 22 can be moved to a suitable elevation for the user in question.

A rough angle of vertical tilt, shown by arrows B in FIG. 1, can be applied to the shower-head holder 24 by hand. However, once at the appropriate elevation, which may well be out of reach for a seated or smaller bodied user, the angle of tilt may need to be refined. In this case, the second user control member 68 of the interface element 50 is operated. To adjust the tilt position, the lever 70 is either pivoted upwards or downwards. Pivoting of the lever 70 about the knuckle housing 74 causes the lower yoke 76 to pivot which moves the lower yoke pin 78 in the lower helical channel 84. This movement causes the axial drive member 80 to rotate slightly, which causes the slider element 86 to rotate about the main axis of the device and relative to the upper yoke pin causing the upper yoke pin 44 to move in the upper helical channel 88 of the slider element 86. Because the upper yoke 38 is held angularly stationary in the horizontal plane by angular fixation of the riser body 22 to the riser rail 12, the upper yoke 38 pivots in the vertical plane, causing the associated pivot block 40 and shower-head holder 24 to also rotate about a horizontal axis. Consequently, the shower head 30 held by the holder 24 is tilted upwards or downwards as necessity dictates.

A pan position of the shower head, shown by arrows C in FIG. 1, may also need to be adjusted. In this case, the second user control member 68, again being the lever 70, is utilised. By rotating the lever 70 only in the horizontal plane causes the knuckle housing 74 to rotate. Since the knuckle housing 74 is fastened to the riser rail 12, which in turn is keyed to the riser body 22, the riser 18 is rotated or panned in the horizontal plane to a desired position.

Referring to FIGS. 7 and 8, a second embodiment of holder apparatus will now be described. Parts which are similar to those described above have the same reference but with a prefix of ‘1’, and further detailed description is omitted.

The second embodiment of holder apparatus 110 operates in the same fashion as that of the first embodiment, and thus comprises the riser bar or rail 112, upper and lower brackets 114 and 16, shower-head riser 118 slidably mounted on the riser rail 112, and adjustment means for adjusting the position of the riser 118 on the riser rail 112.

In this case, the user interface element 150 of the adjustment means includes an epicyclic gear train mechanism 194 within the first user control member 156 or wheel 158. The planet gears 196 of the epicyclic gear train mechanism 194 are rotatably mounted on a platform 198 held stationary relative to the lower bracket 116. The rotatable lower adapter 154 includes the sun gear 200 of the epicyclic gear train mechanism 194, which is angularly fixed relative to the rest of the lower adaptor 116. An inner surface of the first user control member 156 includes a continuous set of teeth 202 which mesh with the planet gears 196.

In this embodiment, three planet gears are utilised in spaced equi-angular relationship. However, one or two planet gears, or more than three planet gears could feasibly be used.

The epicyclic gear train mechanism 194 in this case provides a three to one gear ratio between the rotation of the first user control member 156 and the rotatable elongate helical guide member 160 which is angularly fixed to the lower adapter 154.

The gear ratio ensures the riser 118 will move rapidly along the riser rail 112 when the wheel 158 is rotated by a user, whilst also allowing the helical flute or flutes 162 to be at a suitable pitch such that the riser 118 can be moved along the riser rail 112 directly by hand, for example by a standing user.

It is possible to apply the modification described above to the first embodiment, independently of the further modifications described hereinafter.

Referring to FIGS. 7 and 9, to reduce the possibility of slackness or free-play in the adjustment means, the lower yoke or lower drive element 176 within the knuckle housing 174 and fixed to the pivot axis of the lever 170 is geared to a second lower adapter 204 which is rotatably mounted on and above the first said lower adapter 154. The second lower adapter 204 is keyed to the axial drive member 180, which has the C-shaped lateral cross-section and which is provided within the riser rail 112.

The second lower adapter 204 includes an outrigger arm 206 having a gear segment 208, effectively being a portion of a bevel gear with a cone angle of 0 degrees and commonly known as a face gear. The lower drive element 176 includes teeth 210, in this case being two, from a spur gear. The teeth 210 of the lower drive element 176 mesh with the gear segment 208 of the second lower adapter 204. This geared engagement eliminates undesirable clearances, making the second user control member 168 and the associated adjustment means feel tighter and more responsive, thus improving the feel of quality.

As above, it is possible to apply the aforementioned modification to the first embodiment, in addition to or independently of the other modifications described above and also hereinafter.

Referring to FIGS. 10 to 12, the riser 118, as in the first embodiment, includes the riser body 122 which is slidable along the riser rail 112. The shower-head holder 124 is pivotably connected to one side of the riser body 122.

The pivotable upper yoke 138 is again provided between the two mounting elements 136 projecting from the toroidal casing 134. However, the upper yoke 138 includes a face gear portion 212 adjacent to each mounting element 136.

A secondary upper yoke 214 having an arcuate longitudinal extent similar to the upper yoke 138 is slidably mounted on a land in the toroidal casing 134, preferably so as to be opposite the upper yoke 138. Ends or portions adjacent to the ends of the secondary upper yoke 214 have face gear segments 216 for meshing with the spur gear portions 212 of the upper yoke 138. Partway between the ends of the secondary upper yoke 214, and preferably midway, a further face gear segment 218 is provided.

The toroidal casing 134 includes a support 220 for rotatably supporting a shaft 222 having a spur gear segment 224 at one end. The spur gear segment 224 meshes with the further face gear segment 218 of the secondary upper yoke 214. At the other end of the shaft 222, a follower arm 226 extends at right angles. The follower arm 226 is angularly fixed relative to the shaft 222, so as to rotate therewith. A generally circular or part-spherical follower 228 having a spherical bearing surface is provided on the end of the follower arm 226 so that an axis of the follower 228 is in parallel with, but offset from, the rotational axis of the shaft 222. The follower 228 is provided in slidable and/or rotatable close-fit engagement with the cylindrical edge faces of the slot 182 of the axial drive member 180.

The angle of tilt is thus refined by use of the second user control member 168 of the user interface element 150. The lever 170 is pivoted upwards or downwards. The knuckle housing 174 causes the lower yoke 76 or lower drive element 176 to move. In the former case, this is described in detail in the first embodiment. In the latter case, the lower drive element 176 rotates the second lower adapter 204 about the longitudinal axis of the riser rail 112 through the aforementioned meshed gear engagement. The axial drive member 180 thus rotates slightly, which causes the follower 228 to be slightly angularly moved. This movement of the follower 228 pivots the follower arm 226, which consequently rotates the shaft 222. The spur gear segment 224 at the end of the shaft 222 thus also rotates, causing the secondary upper yoke 214 to angularly slide within the toroidal casing 134. Movement of the face gear segments 216 at the ends of the secondary upper yoke 214 causes the first said upper yoke 138 to pivot. The pivot block 140 and shower head holder 124 which are connected to respective ends of the first said upper yoke 138 thus rotate about their horizontal pivot axes. Consequently, the shower head 30 held by the holder 124 is tilted upwards or downwards as necessity dictates.

Again, it is possible to apply the aforementioned modification to the first embodiment, in addition to or independently of the other modifications described above.

Although the riser bar is typically vertical, there is no reason why the bar could not be provided horizontally. Therefore, the term ‘holder bar’ is used and is intended to cover any bar or rail in any orientation, the term ‘holder element’ is used to cover any type of riser or similar device which travels on the holder bar and which carries a shower head.

In the embodiments described above, the user interface element includes separate first and second user control members. However, it is feasible to provide only the first user control member, being the wheel, to allow height adjustment. Alternatively, it is feasible to only provide the second user control member, being the lever, to allow tilt and pan. In this latter case, the second user control member may be restricted to provide only tilt or only pan, dependent on necessity.

Furthermore, combinations of height, tilt and pan adjustment can be provided. For example, although restrained at or adjacent to the lower end of the holder bar, the first user control member, being the wheel, may have a limited amount of axial freedom. In this case, the tilt adjustment as well as the height adjustment could be operated by a wheel, thereby dispensing with the need for the second user control member, being the lever, if pan was not needed.

The helical channel or flute of the guide member and the mechanical advantage of the mechanism and lever control helical slots within the axial drive members so described are arranged so that the position of the shower head may be conveniently moved vertically or arranged radially by a standing person by direct manipulation of the shower head and holder itself. This provides the combined convenience of a remotely actuated shower head control with the conventional operation of a shower head position by an able bodied user.

In a further modification, the shower head holder may be temporarily disengageable from the helical guide member 60/160 thereby easing or simplifying manual vertical adjustment and repositioning of the holder along the riser rail.

Although the holder apparatus described above is preferably for use with a shower-head holder or riser, it can also be envisaged by those skilled in the art that the apparatus may additionally or alternatively be conveniently motorised or remotely actuated with suitable driving elements positioned on the key rotational axes of the interface element components. This permits power assisted, remote, or simultaneous control and operation by a carer who may stand outside the showering area, who may be able to control the shower head position in conjunction with or independently the bather.

The preceding description of a shower head holder device can therefore be applied by those skilled in the art to the more general control of other devices such as spray heads for paint spraying, other liquid applicators, mechanical manipulation devices or remote control of toxic or hazardous elements or manipulation devices by locating the user interface element on one side of a sealed or otherwise protective barrier, region or room and passing the riser rail through the sealed region or room such that the holder 24, 124 and thus the actuated device is solely within that room. Such an arrangement may necessitate the addition of sealing elements (not shown) around the mutually cooperating rotational surfaces within the interface element. The holder, in this case, can therefore take any suitable or necessary shape or form in order to engage, hold or support the device, element or equipment to be moved.

It is thus possible to provide remotely controllable holder apparatus which can be easily adjusted to a suitable position in terms of distance, tilt and pan. It is also possible to provide a holder apparatus for holding a spray head, such as a shower-head, which enables either manual or motorised remote adjustment of the head to a suitable position in terms of head height, tilt and pan by a seated or smaller bodied user as well as an able-bodied or standing adult.

The embodiments described above are provided by way of examples only, and various other modifications will be apparent to persons skilled in the art without departing from the scope of the appended claims.

1. Holder apparatus comprising: an elongate holder bar; a holder element slidably mounted on the holder bar, the holder element having a item holder; and an adjustment mechanism to adjust a position of the holder element on the holder bar, an adjustment mechanism having a user interface element which is operable by a user to adjust a position of the holder element on the holder bar, the user interface element being at one end of the holder bar and spaced from the holder element, wherein the interface element includes a first user control member which controls a sliding position of the holder element along a longitudinal extent of the holder bar, and a second user control member which controls a tilt position and a pan position of at least part of the holder element, the second user control member being a pivotable and rotatable lever, whereby movement of the lever is replicated by the holder.

2. Holder apparatus as claimed in claim 1, wherein the adjustment mechanism further comprises a drive element which interconnects the interface element with the holder element, the drive element being in the holder bar.

3. Holder apparatus claimed in claim 2, wherein the interface element is at least in part geared to the drive element.

4. Holder apparatus as claimed in claim 2, wherein the drive element includes a rotatable helical guide member along which the holder element moves on operation of the interface element, so that the holder element slides along the holder bar.

5. Holder apparatus as claimed in claim 2, wherein the drive element includes a rotatable axial drive member which engages the holder element, so that at least part of the holder element is tiltable.

6. Holder apparatus as claimed in claim 5, wherein the holder element includes a follower which engages with the axial drive member.

7. Holder apparatus as claimed in claim 6, wherein the holder element includes a gear mechanism operable by the follower to enable tilting of the said at least part of the holder element.

8. Holder apparatus as claimed in claim 1, wherein the holder bar is rotatable and engages the holder element, so that the holder element can pan.

9. Holder apparatus as claimed in claim 1, wherein the interface element includes an epicyclic gear mechanism.

10. Holder apparatus as claimed in claim 1, wherein the user control member is a rotatable wheel which is coaxial or substantially coaxial with the holder bar.

11. Holder apparatus as claimed in claim 10, wherein the rotatable wheel is manually rotatable.

12. Holder apparatus as claimed in claim 1, wherein the user control member is motorised.

13. Holder apparatus as claimed in claim 1, wherein the further user control member is a pivotable and rotatable lever.

14. Holder apparatus as claimed in claim 1, wherein the lever is manually pivotable and rotatable.

15. Holder apparatus as claimed in claim 1, wherein the further user control member is motorised.

16. Holder apparatus as claimed in claim 1, wherein the holder bar includes a slot along its longitudinal extent, a portion of the holder element being received in the slot whereby at least part of the holder element is slidable therealong.

17. (canceled)

18. (canceled)

19. (canceled)

20. (canceled)

21. Holder apparatus as claimed in claim 16, wherein the slot is closed by a flexible seal through which the portion of the holder element extends.

22. Holder apparatus as claimed in claim 1, wherein the spaced user interface element is operable by a user to adjust a longitudinal position, tilt and pan of the item via the holder element on the holder bar.

23. Holder apparatus as claimed in claim 1, wherein the holder bar is a riser rail and the holder element is a riser.

24. Holder apparatus as claimed in claim 19, wherein the riser rail is a shower-head riser rail for a shower installation, and the riser is a shower-head riser which is adapted to hold a shower head.

25. (canceled)

26. (canceled)

27. (canceled)
